(19) United States
(12) Patent Application Publication
(10) Pub. No.: US 2005/0115903 A1
(43) Pub. Date: Jun. 2, 2005

(54) Method and apparatus for extracting nucleic acids from a complex mixture

(75) Inventors: Sylvie Hallier-Soulier, Bruz (FR); Gaelle Leborgne, Rennes (FR); Nadine Batisse-Debitte, Saint-Erblon (FR); Gabriel Festoc, Rennes (FR); Xavier Badiche, Paris (FR)

Correspondence Address: MERCHANT & GOULD PC, P.O. BOX 2903, MINNEAPOLIS, MN, 55402-0903, US

(73) Assignee: GENESYSTEMS, Bruz (FR)

(21) Appl. No.: 10/960,835

(22) Filed: Oct. 6, 2004

Related U.S. Application Data
(63) Continuation of application No. PCT/FR03/01123, filed on Apr. 9, 2003.

(30) Foreign Application Priority Data
Apr. 9, 2002 (FR) 02/04424

(51) Int. Cl. B01D 15/08

(52) U.S. Cl. 210/656; 210/651; 210/198.2; 210/502.1; 435/6

(57) ABSTRACT

The invention relates to a method for extracting nucleic acids of microorganisms contained in a complex mixture, particularly a food mixture, comprising at least the following steps: the mixture is clarified; the microorganisms are retained on a filtering cartridge; said microorganisms are lysed; the nucleic acids are recovered, concentrated, and purified. The invention also relates to a filtering cartridge and an apparatus used for carrying out the inventive extraction method. Also disclosed is a device for extracting, detecting, and if necessary quantifying the nucleic acids of microorganisms contained in a complex mixture.

The present invention relates to the field of analysing biological samples, more particularly to analyzing the bacterial content of complex mixtures, in particular from food samples.

The invention concerns a method for extracting nucleic acids from microorganisms contained in a complex mixture.

The present invention also relates to a filtration cartridge and to an automaton for extracting nucleic acids from microorganisms contained in a complex mixture or in water, said cartridge or automaton being used to carry out the extraction method of the invention.

Finally, the invention concerns a device for extracting and detecting and/or quantifying nucleic acids of microorganisms contained in a complex mixture, said device comprising an automaton for extracting nucleic acids in accordance with the invention, coupled with an automaton for heat-dependent chain amplification of said nucleic acids.

The current mood of the public, representing potential consumers, is symptomatic of a preoccupation with general health and safety since demand for guarantees regarding the safety, quality and provenance of products available on the market is constantly increasing. Further, this phenomenon has become much stronger recently and continues to strengthen. Thus, the public needs positive answers to satisfy the need for certitude and assurances.

In this regard, public bodies and other authorities and organizations in charge of public health and health monitoring make regular checks to ensure strict adherence to safety and quality standards, in particular in the food industry, by producers, manufacturers, distributors and restaurateurs. The quality of microbiological monitoring is a crucial point which must be watched over right along the chain from producer to consumer.

Such checks are based on analytical methods developed from current analytical chemical or biochemical techniques, including chromatography, nuclear magnetic resonance and mass spectrometry, as well as molecular biological techniques which can, for example, detect nucleic acids specific to organisms, in particular pathogenic organisms, by PCR or hybridization using probes.

Those checks can be carried out on a large scale, in particular in the context of agriculture or in the production industry. Further, they are sometimes carried out as a matter of urgency. When suspect products have already been made available for sale, the level of safety of such products should be determined as quickly as possible in order, if appropriate, to order their withdrawal from the market to avoid possible mass contamination.

In particular, health checks are carried out in the context of determining the level of contamination of foods at risk such as meat, fish, dairy products and foods that may have undergone changes resulting from possible temperature-sensitive variations when passing through the different steps in the “cold chain”, as well as in conserving and monitoring the environment, for example when checking the level of pollution in drinking water sources and distribution networks.

In more medical applications, the purity of nucleic acid extracts from biological samples from patients or subjects at risk is an essential criterion in carrying out diagnostic methods, in particular in carrying out tests for detecting or for a predisposition to genetic disease.

In any event, samples removed in situ must be treated with the shortest possible delay to ensure optimum efficacy and safety.

One of the first steps in treating biological samples can consist of in vitro manipulation of nucleic acids for qualitative and/or quantitative analysis, more precisely of isolating said nucleic acids from their cellular environment.

Nucleic acids, DNA and RNA, are the target for multiple interactions linked to biological methods in which said nucleic acids play a fundamental role. As an example, they interact directly with enzymes responsible for gene expression, and with protein factors for regulating said expression, this constituting a fundamental biological method contributing to cell survival, development and renewal.

Such complexes associating nucleic acids of interest with proteins and/or other nucleic acids considerably complicate isolation and purification of just the nucleic acids being investigated.

To overcome this difficulty, conventional methods for extracting nucleic acids generally sacrifice processing time for the degree of purity of the extracts obtained. In principle, such methods comprise at least the following three steps: (i) lysis of cellular envelopes to liberate the nucleic acids into the medium; (ii) denaturing nucleic acid-protein complexes; and (iii) separating nucleic acids of interest from other macromolecules (Sambrook and Russel, 2001: “Molecular Cloning: A Laboratory Manual”, 3^{rd} edition, Cold Spring Harbor Laboratory Press, Cold Spring Harbor, N.Y.).

Said conventional methods, while mainly following the framework represented by the three steps mentioned above, are modified empirically as a function of the different aims to be achieved. Thus, their implementation differs substantially depending on whether the aim consists of isolating (i) DNA and/or RNA, (ii) from cells of prokaryotic or eukaryotic organisms, knowing that in the case of prokaryotic organisms, it may be appropriate to (iii) discriminate between DNA of plasmidic or chromosomal nature.

Within the aforementioned framework there is an essential step consisting of extracting nucleic acids using organic solvents such as phenol, chloroform, isoamyl alcohol or a mixture thereof. The desired nucleic acids, contained in the aqueous phase, are then recovered after separating the organic and aqueous phases by centrifuging.

Implementing such a step represents one if not the principal limitation of prior art procedures for extracting nucleic acids. Centrifuging, necessary for separation of the organic and aqueous phases, constitutes a major obstacle to automating the method, firstly by necessitating intervention by an operator and secondly, by the high costs of carrying it out because the units are expensive and bulky.

Finally, the majority of conventional cell lysis methods can extract nucleic acids not in their native form but in the form of large fragments (50 kb). Subsequent purification of the nucleic acid extracts using organic solvents such as a phenol-chloroform mixture can cause shearing of said nucleic acids, which then generates heterogeneous fragments of less than 50 kb.

Such an “experimental quirk” may prevent or falsify interpretation of the results, in particular when the skilled person discriminates products derived from extraction solely on the basis of their size, using gel electrophoresis techniques for example, the latter then suffering from smearing which make the nucleic acid fragments appear as marks in which several bands corresponding to several nucleic acid fragments are collected rather than perfectly discrete bands. This “artifact” can also cause a substantial reduction in sensitivity during detection of nucleic acids extracted by hybridization methods, in particular on membranes.

To overcome this prior art disadvantage, an automaton for extracting and purifying nucleic acids from cells has been described, in European patent EP-A-0 245 945. That automaton carries out the extraction step using an organic solvent based on phenol, dispensing with the multiple centrifuging steps necessary until then. Briefly, an emulsion is generated by adding solvent to the cell lysate, that emulsion being heated to cause phase separation. A final chloroform extraction step is carried out.

Notwithstanding its possible automation, that method does not overcome the problem of the prior art, and in particular that linked to using organic solvents. While extraction using said solvents effectively eliminates contaminants, namely the detergents used in the step for lysing cells and proteins, they still remain highly toxic. As a result, their manipulation necessitates vigilance and care and must be confined to safety stations having suitable ventilation.

To overcome the disadvantages mentioned above and observed with prior art nucleic acid extraction methods, said methods being difficult to reconcile with the safety, efficacy and reliability standards of modern industry and analytical laboratories, an alternative approach has been described in International patent application WO-A-93/01312.

That application discloses a cartridge for preparing nucleic acids, in particular for preparing genomic DNA, from a blood sample, cell tissue sample or cultured cell tissue sample, in other words suspensions of relatively homogeneous eukaryotic cells, in a biological fluid or a culture medium.

International patent application WO-A-93/01312 also describes a device and method using that cartridge.

The cartridge comprises a dialysis chamber defined by dialysis membranes. If necessary, the cartridge also comprises a filter for retaining cell nuclei.

International patent application WO-A-93/01312 proposes a method for preparation, i.e. isolation and purification of nucleic acids from a sample containing eukaryotic cells by lysing nuclei, degrading proteins and purifying said nucleic acids by dialysis.

However, the technology relating to the extraction cartridge described in International patent application WO-A-93/01312 is not suitable for extracting nucleic acids from prokaryotes which may be present in heterogeneous complex mixtures such as untreated food samples which have not already been modified, for example by drying, the constituents of which are partly solid and partly liquid.

In fact, the invention proposes a method for extracting nucleic acids from prokaryotes which can be automated and which is suitable for the treatment of a complex starting medium.

The method of the invention, which can be automated in its entirety, thus satisfies the criteria of rationalization and economy in that it (i) is directly applicable to extracting nucleic acids from unrefined samples, even if they are complex and heterogeneous in terms of composition and structure; (ii) it allows rapid extraction which is complete in less than 3 hours; (iii) it supplies reproducible results; (iv) if allows up to six different samples to be treated simultaneously while ensuring their traceability at each step; (v) it can be carried out by unqualified personnel; (vi) it requires neither intervention nor monitoring by the operator apart from very briefly; the operator is thus free to carry out other operations or studies during the course of the extractions; and (vii) it can be carried out routinely on the analytical laboratory or industrial scale without necessitating heavy investment as regards equipment.

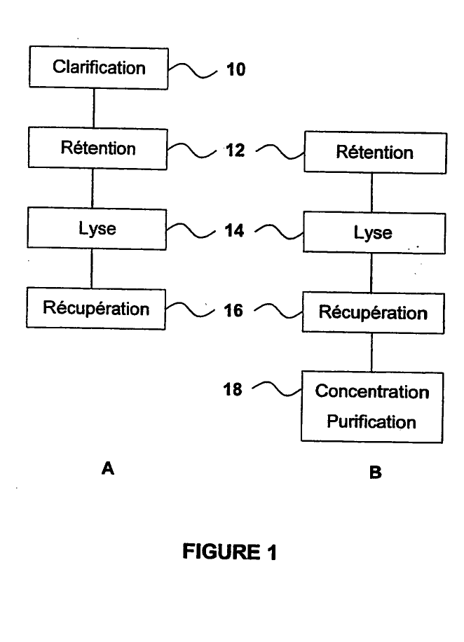

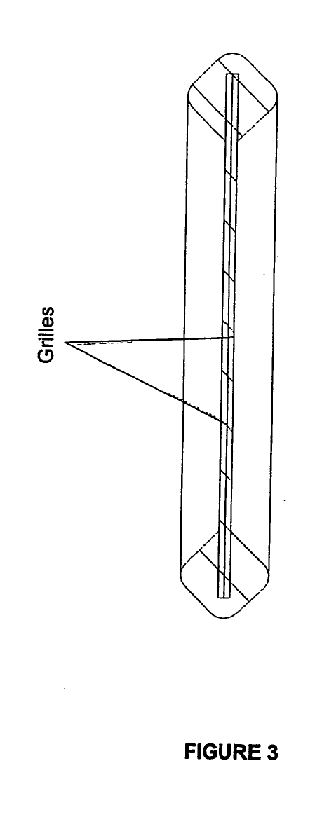

Thus, the invention concerns a method for extracting nucleic acids from microorganisms contained in a complex mixture, especially food, said method comprising at least the following steps:
(12) retaining the microorganisms contained in the mixture on a cartridge type filtration device 40 (see FIG. 3);
(14) lysing the microorganisms in situ;
(16) recovering nucleic acids from the filtration cartridge 40 (FIG. 1).

Depending on the nature of the sample to be analyzed (solid/liquid ground food or water, for example drinking water), a first step is required:
(10) clarification of said mixture by filtration on a cartridge type prefiltration device (FIG. 1, track A), step (12) then being carried out on the filtrate.

When the nucleic acids are extracted for quantification, a supplemental step is required:
(18) concentrating and purifying the nucleic acids by liquid-solid adsorption chromatography (FIG. 1, track B).

Steps 12, 14 and 16 refer to a “cartridge type filtration device” 40 (FIG. 3). This designation and the equivalent terms and expressions “cartridge”, “extraction cartridge” and “filtration cartridge” denote a system comprising a retention filter 42 trapped between two screens or bonded to a single screen, the screen(s) being held by any means, for example two bonded, screwed or clipped rings, or being mounted in a ring.

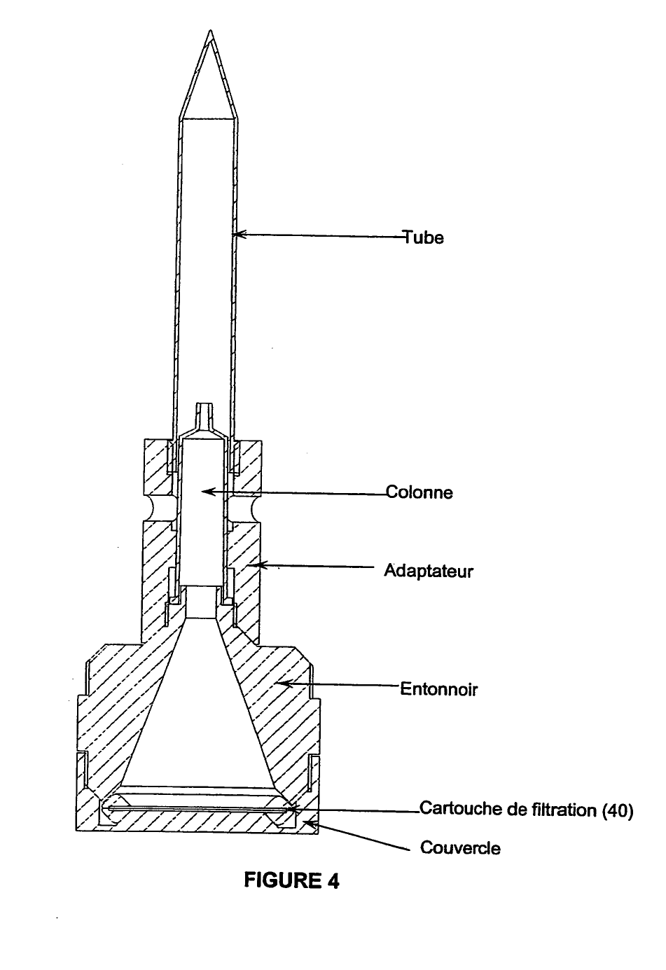

Said cartridge can undergo lysis treatments (FIG. 4). In this case, the plastic part on which the filtration cartridge is placed is unscrewed from the filtration station and the lower face of the cartridge—i.e. the face which is not in contract with bacteria—is sealed using a cover. The upper face of the filtration cartridge is sealed by a device comprising a funnel, an adapter, a lysate clarification filter and a 15 ml conical bottom tube. The adapter is screwed onto the funnel. It contains the lysate clarification filter which has been inserted in the adapter. A 15 ml conical bottom collecting tube is screwed onto the free end of the adapter, as shown in FIG. 4.

Said system has original features because of the characteristics of the filters of which it is composed. As will be seen in the detailed description of the invention which follows, selection of the filters is an essential element in obtaining the anticipated result. A description of the filtration cartridge 40 of the present invention is provided below.

Within the context of the present invention, the term “extraction” of nucleic acids encompasses isolation of said nucleic acids from their natural biological environment, purification and concentration. The degree of purity and concentration of the nucleic acids extracted using the method of the invention are such that said nucleic acids can be used for detection using methods that are as sensitive as PCR, directly and without having recourse to any supplemental treatment for eliminating residual contaminants that may inhibit or alter the specificity and sensitivity of said methods, in particular PCR reactions.

The term “nucleic acids”, as is usual, encompasses DNA and RNA. It is clear that said method can be used both for detecting DNA alone by adding RNAses at a step which the skilled person can readily select, as well as RNA alone, by adding DNAses and antiRNAses, in addition to DNA and RNA.

The term “nucleic acids of interest”, “investigated”, “desired” or any other equivalent designation can readily be identified by the skilled person as the target nucleic acids of the extraction method of the invention, said nucleic acids constituting the starting material for the subsequent qualitative and/or quantitative analytical procedure.

The term “microorganism” as used here means any prokaryotic organism, this definition encompassing both Gram positive and negative bacteria as well as those with no walls, and also the sporulated forms of bacteria.

The term “complex mixture” as used in the present invention refers to any composition containing cells of prokaryotic organisms, said composition possibly being heterogeneous in nature, one illustration being an untreated food sample characterized in that it comprises a greater or lesser number of different elements, certain of which are liquid and others of which are solid, or of a more homogeneous nature, which then, for example, correspond to a bacterial culture of greater or lesser purity.

The extraction method of the invention uses membrane or filtration separation techniques which employ porous membranes which are termed permselective membranes by reference to their selective properties and the function of which is similar to that of a barrier with a sieve effect: molecules or particles the approximate size of which is above a given threshold corresponding to the mean pore size of the membrane are retained, while those the size of which is below that threshold pass through the “barrier” under the action of a flux of solvent generated by application of a pressure gradient.

In this regard, passage through the sieve constituted by the porous membrane can separate two liquids, the permeate or filtrate which has passed through the pores of said membrane, and the retentate which is enriched with respect to the initial liquid in species with a mean diameter that is above that of the pores.

Ultrafiltration and microfiltration constitute particular filtration techniques that should be distinguished.

Ultrafiltration uses microporous membranes the pore diameter of which is generally in the range 1 to 100 nm. Such membranes allow small molecules (water, salts) to pass through and retain high molecular mass molecules (polymers, proteins, colloids). Notwithstanding the range relating to the pore diameter indicated above, in order to characterize the membrane in the ultrafiltration field, it is normal to use the concept of the cutoff threshold rather than pore size. The cutoff threshold is defined as the mass, expressed in Daltons, of the molecule which is 90% or 95% retained by the membrane in question.

Microfiltration consists of a method for solid-liquid separation employing membranes the mean pore diameter of which is in the range about 0.1 to 10 μm. This method can thus retain particles in suspension.

The filtration methods can be employed in different modes and configurations, the flow type and geometry of the device housing the membrane having a determining effect on the separation yield. Examples of possible modes and configurations are given below by way of indication.

In frontal filtration, the liquid containing the species to be separated is supplied perpendicular to the membrane, while in the tangential mode, the porous membrane is swept tangentially by said liquid.

The planar configuration facilitates assembly/dismantling operations and can be used with viscous fluids. However, the risk of limiting phenomena occurring as defined below, in particular clogging, must be considered when implementing the filtration method in the planar configuration.

A spiral configuration consists of a planar membrane wound about itself. The filtrate is then collected from the central lumen. This configuration is advantageous from the point of view of compactness, but renders cleaning of the membrane arduous and the filtration system is impossible to dismantle. Further, it generates clogging phenomena which are not negligible.

In the tubular configuration, the membrane follows the interior of a cylindrical matrix of porous steel or glass fiber. A solution to be filtered is supplied from inside the matrix, said solution then traversing the membrane under pressure and the filtrate then being recovered from the outside of the matrix. This system has the advantage of being easy to clean simply be reversing the filtration flux, but it demands large volume units.

The choice of operating conditions for the filtration method is generally governed by the need to reduce limiting phenomena, including choking or clogging of the membrane and concentration polarization.

Clogging consists of physical, chemical and biological phenomena which occur at the membrane-solution interface. It is characterized by a modification to the filtration properties of the membrane when in use, primarily because of deposition and/or adsorption phenomena causing an accumulation of matter in the pores then on the surface of said membrane. Thus, clogging causes immediate pore obstruction, which causes variations both in the permeability and selectivity; the impact on separation efficacy can be serious and sometimes dramatic.

Since the membranes used have the property of carrying out separation on a molecular or particulate scale, the accumulation of species (molecules or particles), which are progressively slowed then stopped at the surface of said membranes, is an unavoidable phenomenon inherent to filtration methods. Said phenomenon, termed concentration polarization, generates a diffusion flux from the membrane towards the core of the solution to be treated, i.e. in the direction opposite to that of the filtration flux which the operator wishes to impose on said solution. Concentration polarization thus induces a reduction in the filtration flux and a variation in selectivity, the deposit connected with the accumulation possibly acting as a “second membrane”, and clogging of the membrane pores because of surface precipitation or gelling, the accumulated species forming networks with a quasi solid appearance.

During step 10 of the extraction method of the invention (which is not indispensable when the material to be analyzed is water), the starting material, namely the complex mixture, is filtered to retain particles with a mean pore diameter of more than about 5 μm, preferably more than about 8 μm.

The term “membrane” or “filter” as used in the present invention means any device satisfying the definition of a “permselective membrane” as described above.

The filtration method carried out in step 10 is of the frontal microfiltration type, said microfiltration being carried out in the planar mode under vacuum.

The implementation parameters of this microfiltration step were dictated by the dual aim to be achieved, namely to discriminate by size the debris contained in the complex mixture, which may contain eukaryotic cells (which are to be eliminated) and prokaryotic cells, for which the tolerated loss level must be a minimum, and to avoid any limiting phenomenon such as clogging and concentration polarization.

To this end, step 10 is carried out using a filter constituted by a material suitable for treating viscous liquids highly charged with particles, such as polycarbonate and cellulose nitrate, said filter being disposable to avoid any risk of contamination between the different samples that may be treated simultaneously. The mean pore diameter of said filter is in the range 1.2 to 12 μm, preferably substantially 5 μm.

Step 12 of the extraction method of the present invention consists of microfiltration carried out in planar mode, tangentially, under vacuum.

The retention filter 42 used in this step, incorporated into the filtration cartridge 40, is chosen to selectively separate the species contained in the filtrate from step 10 and to enrich it in microorganisms, while allowing as much debris and undesirable species as possible to pass.

The criteria guiding the choice of filter, namely a minimum percentage of loss of microorganisms in the filtrate and an absence of phenomena that may limit filtration efficacy, have led the inventors to select a polycarbonate or cellulose nitrate filter for the uniformity of its pore structure and its high non specific adsorption power. The selected filter 42 has a mean pore diameter in the range 0.22 to 0.55 μm, with a preferred value being of the order of 0.45 μm.

Step 14 of the extraction method of the invention relates to chemical and/or mechanical lysis of the microorganisms contained in the retentate from step 12 of said method. As indicated above, this step is carried out in situ, i.e at the level of the filtration cartridge 40.

The inventors aimed to develop a lysis procedure that was (i) effective; (ii) adapted to the biodiversity of complex starting mixtures, possibly comprising Gram positive bacteria and spores the lysis of which is long and difficult using conventional methods; and finally (iii) suitable for automation of the whole method.

The term “chemical lysis” means the action of a detergent on prokaryotic cells, said detergent being contained, for example, in a lysis buffer comprising:
Tris-HCl (pH between 7 and 9, preferably about 8; and concentration between about 25 and 400 mM, preferably about 100 mM);
As appropriate, the following three components:
   EDTA (pH between about 7 and 9, preferably about 8; and concentration between about 10 and 100 mM, preferably about 40 mM);
   NaCl (50 to 800 mM, preferably about 200 mM);
   SDS (between about 0.5% and 8%, preferably about 2%);
      the mixture of the four above components forming a buffer known as TENS (Kuske et al, 1998, Appl Environ Microbiol 64: 2463-2472); and
Chelex-100 (between about 3% and 60%, preferably about 15%).

The mechanical treatment consists of ultrasonicating prokaryotic cells fixed on the retention filter, said ultrasonication being carried out under the same buffering conditions as chemical lysis, in an ultrasound bath at temperatures in the range 60° C. to 100° C., and preferably about 70° C. Alternatively, said mechanical treatment can be carried out at ambient temperature and dry, i.e. by directly fixing the receptacle containing the solution to be lysed on the ultrasound generator without using a bath, each lysis cartridge being placed directly on an independent sonotrode.

The chemical treatment carried out alternately or subsequent to mechanical treatment is carried out hot. The expression “hot” as used in the present invention encompasses temperatures in the range 80° C. to 120° C., preferably close to 100° C.

In a preferred implementation of the present invention, step 14 of the extraction method comprises a mechanical treatment at ambient temperature and dry, followed by a chemical treatment, said treatment being as described above.

Highly denaturing chaotropic agents can optionally be added to the lysis buffer to inhibit the DNAse and RNAse activities that may reduce the extraction yield of nucleic acids. Non limiting examples of chaotrophic agents that can be used in the method of the invention include guanidium thiocyanate, guanidium chloride, urea, perchloric acid, trichloroacetic acid, sodium thiocyanate, sodium iodide, guanidium isothiocyanate and hexadecyltrimethylammonium bromide (CTAB).

In one mode for implementing the extraction method of the present invention (FIG. 1, track A) during step 16, the solution containing the nucleic acids of interest is recovered from cartridge 40 by applying a vacuum. Advantageously, said cartridge 40 is washed at least once with TE 1× buffer to minimize the loss of nucleic acids.

The aim of step 18 is to concentrate and purify the nucleic acids on a silica column. In this case, liquid-solid adsorption chromatography is used, which is a separation mode based on distributing solutes between the fixed adsorbant and the mobile liquid phase. Silica is a dipolar adsorbant. Fixing by adsorption is due to establishing secondary surface bonds or dipole-ion bonds, between the adsorbant and the adsorbed molecule.

Step 18 thus breaks down into at least four sub-steps:
181) diluting the nucleic acid extract, especially in the presence of absolute ethanol to optimize bonding of said nucleic acids to the silica;
182) depositing the mixture on a silica column;
183) washing said column once or more times followed by drying; and
184) eluting nucleic acids retained on the silica column.

During sub-step 182, the nucleic acids are adsorbed on the silica in the presence of high concentrations of chaotropic salts which eliminate water from the hydrated molecules of the solute.

Polysaccharides and proteins are not adsorbed and are eliminated during sub-step 183.

In sub step 184, purified nucleic acids are eluted under low salinity conditions.

Preferably, sub-steps 181 to 184 are carried out under vacuum to avoid having to resort to centrifuging, in particular to elute the washing buffer and the solution of nucleic acids.

In a preferred implementation, the extraction method of the present invention comprises additional preliminary steps which are aimed at facilitating subsequent manipulations of the complex mixture represented, for example, by a food sample such as a minced meat type meat product or a cheese type dairy product.

Said preliminary steps consist of:
26) grinding the complex sample, in particular a food sample; and
28) pre-treating enzymatically and chemically the obtained ground mixture.

The invention also concerns a filtration cartridge 40 for use in carrying out steps 12 and 14 (FIG. 1, track A) of the method for extracting nucleic acids from microorganisms.

When the concentration and purification step is carried out by chromatography (step 18), cartridge 40 comprises a polycarbonate retention filter 42 the mean pore diameter of which is preferably 0.45 μm, inserted between two filtration supports (screens), the whole being maintained by two polymer rings as shown in FIG. 3. This cartridge can be sealed to undergo lysis treatments (FIG. 4) or, alternatively, the retention filter is mounted in an injected polymer ring. In this case, the part on which the filtration cartridge is located is unscrewed from the filtration station and the lower face—i.e. the face which is not in contact with bacteria—of the cartridge is sealed with a cover. The upper face of the filtration cartridge is sealed with a device comprising a funnel, an adapter, a lysate clarification filter and a 15 ml conical bottom tube. The adapter is screwed onto the funnel. It contains the lysate clarification filter which has already been inserted in the adapter. A 15 ml conical bottom tube is screwed into the free end of the adapter, as shown in FIG. 4.

In a further aspect, the invention provides an automaton for extracting nucleic acids from microorganisms contained in a complex mixture, in particular of food, or in water, said automaton being suitable for carrying out the extraction method of the invention.

The term “automaton” designates a device or apparatus which can carry out a method, linking together the essential steps in an autonomous manner without needing the assistance, intervention or surveillance of an operator except briefly and not essentially, for example to ensure a connection between two essential steps.

The invention also concerns a device for extracting and detecting and, as appropriate, quantifying nucleic acids from microorganisms contained in a complex mixture, especially of foods, said device comprising an automaton for extracting nucleic acids in accordance with the present invention, coupled to an automaton for thermo-dependent chain amplification of said nucleic acids.

In a preferred implementation, the automaton for thermo-dependent chain amplification incorporated into the device of the invention is rotary in type.

An automaton for thermo-dependent chain amplification of nucleic acid sequences for use in the device of the present invention has been described in United States patent application U.S. Ser. No. 09/981,070 which claims priority from French patent application n°0010029. An example of such a device comprises: (i) a cartridge comprising a plurality of reaction chambers containing pairs of primers for amplifying specific nucleic sequences, to which are connected a reservoir for supplying purified nucleic acid extract acting as matrices during said amplification; (ii) a heating platen at least two distinct zones of which can be heated to at least two different temperatures and maintained constant, each temperature then corresponding to a given step in the amplification cycle, namely the denaturing, hybridization or elongation step; (iii) means for relative displacement between the cartridge and the platen, said displacement ensuring cyclic exposure of the reaction chambers to the temperature of each of the zones of the platen, which allows the cycles of the amplification reaction occurring inside said chambers to be automatically linked together.

The present invention will now be illustrated in a non limiting manner in the following figures:

FIG. 1: Diagram of the nucleic acid extraction method;

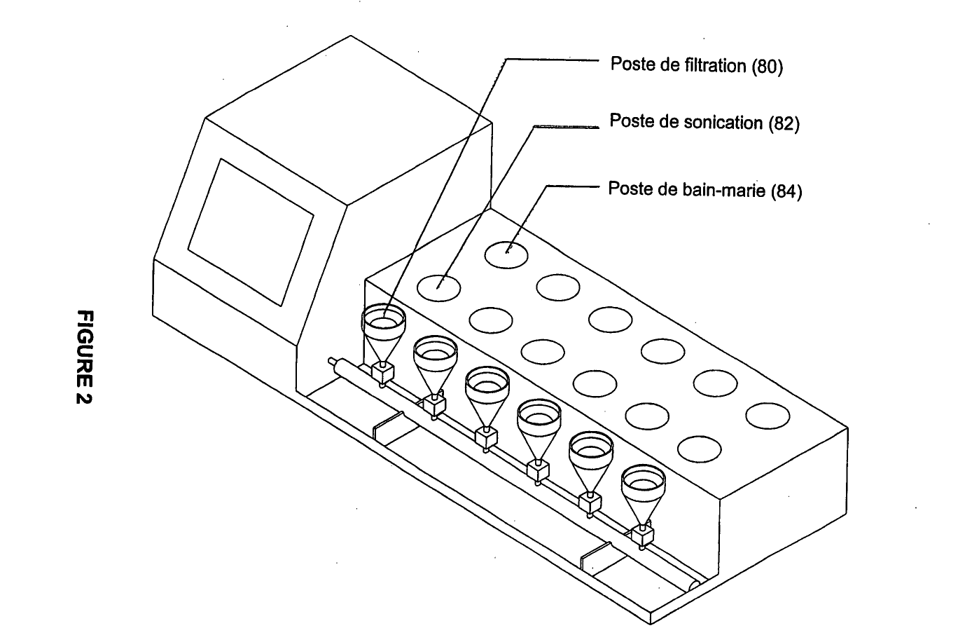

FIG. 2: Diagram of automaton for extracting nucleic acids. It shows three stations, namely station 80 carrying out steps 10 (optional), 12, 16 and 18 of the extraction method, and stations 82 and 84 carrying out step 14;

FIG. 3: Diagram of a filtration cartridge;

FIG. 4: Diagram of an assembly for carrying out step 14 of the extraction method;

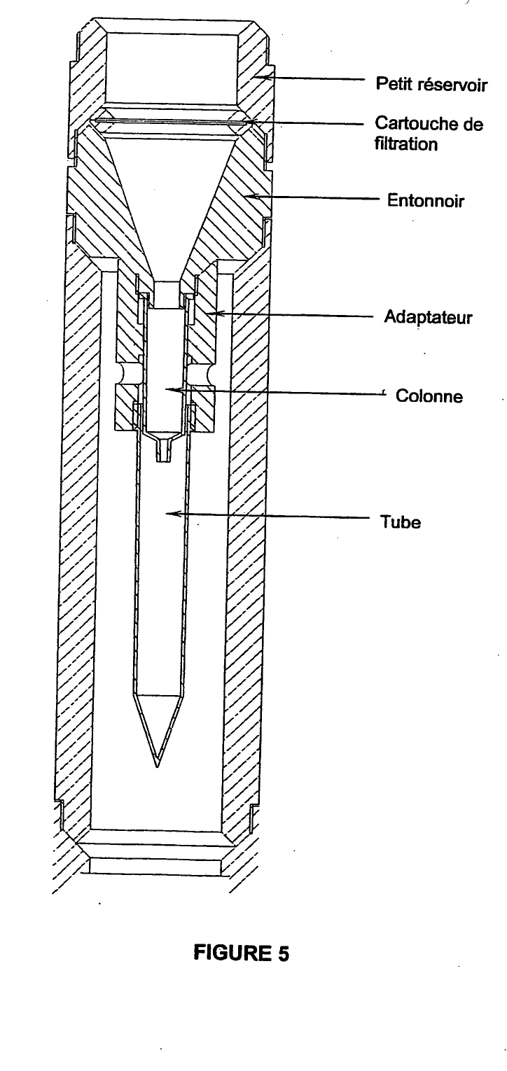

FIG. 5: Diagram of assembly for carrying out step 16 of the extraction method.

The invention will be better understood from the following examples given purely by way of illustration. It should be understood that the present invention is in no way limited to said examples.

### EXAMPLES

The nucleic acid extraction method of the invention was tested on two complex food mixtures, namely a minced steak type meat product and a soft cheese sold under the trade mark Babybel®, as well as a sample of drinking water. The two complex food mixtures illustrate track A of FIG. 1 of the present invention, while the tap water sample illustrates track B of FIG. 1 of the present invention.

The two complex mixtures were inoculated with known quantities of two different microorganisms (Listeria monocytogenes and Salmonella ser. Enteritidis), said microorganisms being selected to verify the efficacy of extraction of nucleic acids from Gram positive and Gram negative bacteria using the method of the invention. The drinking water sample was inoculated with known quantities of a strain of Legionella pneumophila serogroup 1.

I—Grinding the Food Sample

In accordance with current standards set and distributed by the Association Francaise de Normalisation (AFNOR) [French Standards Association] and the Fédération Internationale de Laiterie (FIL) [International Dairy Federation], the food sample was ground using a Stomacher to prepare a mother suspension.

An aliquot of the food sample, 25 g, was suspended to 1/10 in a diluent in accordance with standards NF V 08-010 (March 1966, AFNOR, Paris, France), NF V 04-501 (April 1998, AFNOR) and FIL 122C: 1996 (December 1996, FIL, Brussels, Belgium). In accordance with these standards, the composition of the diluent is a function of the type of food under consideration. In the present case, the minced steak and the cheese were respectively suspended in buffered peptonized water and 20 g/l sodium citrate.

The suspensions obtained were ground for 3 minutes.

10 ml aliquots of the ground material, corresponding to 1 g of starting food, were removed to extract the nucleic acids.

The food matrices could also be treated after enriching them with target microorganisms in specific culture media depending on the microorganisms being investigated, in accordance with current AFNOR standards. In this case, enzymatic pre-treatment was directly applied to 10 ml of enriched medium.

II—Enzymatic and Chemical Pre-Treatment of Food Sample

This step hydrolyzed fat globules and protein micelles to avoid phenomena such as clogging which could reduce the yield of subsequent filtration steps.

The compositions of the pre-treatment solutions were determined empirically from a bibliographical study (Driehus and Teemstra 1992, Neth Milk Dairy J 46: 209-215; Starbuck et al, 1992, Lett Appl Microbiol 15: 248-252; Yang and Lundahl, 1994, Anal Biochem 281: 210-221; Rijpens et al, 1996, Appl Environ Microbiol 62: 1683-1688).

The additives supplied to each 10 ml aliquot were composed of 0.2 g of trypsin for the minced steak ground material, and 0.2 g of pancreatin, 10 mM of EDTA, 5% of Triton and 4% of cholic acid for the cheese ground material.

The samples were incubated at 25° C. for 1 hour for the minced steak ground material, and at 30° C. for 1 hour 30 minutes for the cheese ground material. This incubation step allowed neither significant bacterial growth nor “premature” lysis of prokaryotic cells, two phenomena which could ruin the yield of the procedure.

III—Microfiltration of Ground Food Material (Step 10)

III-1—Summary of Protocol

Having regard to the requirement that clogging should be avoided, cellulose nitrate filters with a mean pore diameter of 8 μm were selected.

Microfiltration was carried out in the planar mode under vacuum.

Each 10 ml of pre-treated ground food product was filtered. Depending on whether it was minced steak or cheese, the microfiltration device was washed with 40 ml of TE 1× buffer (Tris-HCl 10 mM pH 8.0 and EDTA 1 mM pH 8.0) or 10 ml of 0.5% Triton (diluted in sterile distilled water) pre-heated to 50° C., respectively. This washing step was aimed at limiting the loss of material, in particular bacteria of interest, and to dilute the samples to avoid clogging, in particular during the subsequent filter retention step.

Following the microfiltration step, 20 and 50 ml of filtrate containing the target bacteria were recovered for each 10 ml of initial ground cheese and minced steak material respectively.

111-2—Automaton Implementation Conditions

This step was carried out at the filtration station connected to a pump, using an assembly comprising, from top to bottom, a disposable funnel, a disposable pre-filtration cartridge, a plastic cylinder and a disposable retention cartridge. This assembly was connected to the filtration station 80 via a plastic part (FIG. 2).

Microfiltration was carried out in planar mode.

The liquids (ground food material supplemented with washing buffer) were distributed manually.

IV—Retention of Microorganisms (Step 12)

IV-1—Summary of Protocol

After a number of retention filter tests made having regard to the criteria regarding clogging avoidance, the best results were observed with polycarbonate filters with a mean pore diameter of 0.45 μm.

The 40 ml filtrate was filtered on a selected retention filter 42.

The filtrate was removed and the retention filter 42 was placed in a polypropylene tube.

Regarding the drinking water samples, the steps for grinding the sample and enzymatic and chemical pre-treatment were not necessary (FIG. 1, track B). In accordance with current standards made and distributed by AFNOR, the test aliquot for the drinking water was in the range 250 ml to 21, preferably 11. This test sample was directly filtered on polycarbonate filters with a mean pore diameter of 0.45 μm to retain bacteria of the genus Legionella.

IV-2—Automaton Implementation Conditions

Since pre-filtration and retention were carried out in sequence, at the end of pre-filtration, the 40 ml filtrate was supplied directly via a cylinder to the retention cartridge 40 located at the inlet to module 80 of the extractor (FIG. 2).

A waste tank was provided to evacuate the filtrate.

V—Lysis of Target Microorganisms (Step 14)

V-1—Summary of Protocol

At the end of the preceding step, the retention filter 42 was deposited in a polypropylene tube, that material being close to the polymer required to manufacture the filtration cartridge 40.

The retentate fixed on the retention filter 42 was suspended in 1 ml of Tris-HCl 100 mM pH 8.0 —Chelex-100, 25% lysis buffer.

The polypropylene tube containing the retention filter 42 and the lysis buffer were placed in a 120 W sonication bath. Sonication was carried out at 70° C. for 40 minutes and at 80% of the maximum power of the sonicator, giving a power in the range 80 to 120 W, preferably 100 W.

The tube was then incubated in a water bath for 10 min at 100° C.

V-2—Automaton Implementation Conditions

The plastic part positioned at the filtration station of the pump onto which the filtration cartridge was connected was unscrewed. The lower face of the filtration cartridge was closed by a cover. 2 ml of Tris-HCl 100 mM pH 8.0—Chelex-100, 25% lysis buffer was deposited on the filtration cartridge. The upper face of the latter was closed with a funnel onto which an adapter comprising a lysate clarification column and a 15 ml tube had been screwed (FIG. 4).

The assembly to carry out lysis was then placed by the operator onto a sonotrode at module 82, for 40 min at a frequency of 35 KHz. The cartridge was incubated by the operator in a dry bath at module 84 for 10 min at 100° C.

VI—Recovery of Nucleic Acids (Tracks A and B, Step 16)

VI-1—Summary of Protocol

The bacterial lysate contained in the polypropylene tube was removed using a 1 ml pipette and deposited in a new tube provided with a filter column. The lysis tube was then rinsed with 1 ml of TE 1× which was also removed and deposited on the filter column. The lysate was then filtered on the filter column under gravity. The filtered lysate was removed and analyzed directly using PCR, or concentrated and purified in accordance with step 18 of track B (FIG. 1).

VI-2—Automaton Implementation Conditions

The assembly required to carry out lysis, containing the filtration cartridge 40, was placed on the filtration station at module 80 by the operator. After replacing the cover with a small reservoir (FIG. 5), the pump was connected to filter the lysate through the “filter” column. The operator then deposited 1 ml of TE 1× on the filtration cartridge 40, the TE allowing the retention filter 42 to be rinsed. The polypropylene tube containing the filtered lysate was removed and the DNA was analyzed directly by PCR or concentrated and purified in accordance with step 18 of track B (FIG. 1).

VII—Concentration and Purification of Nucleic Acids by Liquid-Solid Chromatography (Track B; Step 18)

VII-1—Summary of Protocol

The nucleic acids were purified and concentrated using a silica column such as that available in the “Nucleospin Plant L” system (Macherey-Nagel, Düren, Germany).

A silica column was placed on a vacuum chamber that could treat a plurality of samples simultaneously. Said chamber was constituted by a glass tank provided with a manometer and a polypropylene cover, the outer face of said cover receiving the columns and its inner face receiving disposable needles allowing liquid transfer.

As appropriate, the vacuum in each column could be adjusted using a movable tap.

In the glass tank was a support allowing tubes to be placed beneath each needle to recover the various liquids (binding buffer and ethanol, washing solutions, eluate).

The nucleic acids (1 volume) were mixed with 1 volume of binding buffer (buffer “C4” in the commercial system described above) and 1 volume of absolute ethanol. This mixture was stirred vigorously for 30 seconds then deposited on a column as describe above.

The silica column was first washed with 1 ml of “CQW” washing buffer then with 2 ml of “C5” buffer, said buffers being provided in the “Nucleospin Plant L” system.

The tube placed in the glass tank and containing waste from the washing steps was emptied.

A vacuum was then applied for 12 minutes to dry the column.

200 μl of“CE” buffer, preheated to 70° C., was incubated on the column for 5 minutes.

After vacuum eluting in a new tube, the preceding step was repeated once. The nucleic acids were then eluted under vacuum for 5 minutes.

The volume of nucleic acids so purified was between 15 and 250 μl, preferably 200 μl.

VII-2—Automaton Implementation Conditions

At the filtration station, the adapter containing a polypropylene tube for collecting the filtered lysate and the filter column were unscrewed. The filter column was removed and replaced with a silica column to concentrate and purify DNA. At this stage, the column was not packaged in a tube to allow elimination of the lysate (containing no more DNA which would have been retained on the silica) and washing liquids, which were directly collected in a waste container.

The filtered lysate contained in the polypropylene tube (1 volume) was mixed with 1 volume of bonding buffer (“C4” buffer from the system sold by Macherey-Nägel) and 1 volume of absolute ethanol. This mixture was stirred vigorously for 30 seconds then deposited at the filtration station onto the newly installed silica column. After connecting the pump to allow filtration of the lysate on the silica column, the DNA retained on the silica was washed with 1 ml of “CQW” washing buffer then with 2 ml of “C5” buffer, said buffers being supplied in the “Nucleospin Plant L” system and manually distributed by the operator.

A vacuum was then applied to 15 minutes to dry the column.

A new tube for recovery of the concentrated and purified DNA was screwed onto the free end of the adapter.

200

μl of TE 1× buffer preheated to 70° C. was incubated on the column for 5 minutes. After vacuum eluting for 1 minute in a new tube, the preceding step was repeated once.

The volume of nucleic acids so purified was between 100 and 300 μl, preferably 200 μl.

1. A method for extracting nucleic acids from microorganisms contained in a complex mixture, in particular of foods, or in water, said method comprising at least the following steps:
(12) retaining the microorganisms contained in the mixture on a cartridge-type filtration device 40;
(14) lysing the microorganisms in situ; and
(16) recovering nucleic acids from the filtration cartridge 40.

2. A method according to claim 1, in which step (12) is preceded by a step (10) for clarifying the complex mixture by filtration, said step (12) then being carried out on the filtrate from step (10).

3. A method according to claim 2, in which the step (10) for clarifying the complex mixture is carried out using a disposable polycarbonate or cellulose nitrate filter with a mean pore diameter in the range 1.2 to 12 μm, preferably 5 μm.

4. A method according to claim 1, in which step (16) is followed by a step (18) for concentrating and purifying nucleic acids by liquid-solid adsorption chromatography.

5. A method according to claim 1 in which the cartridge (40) used in steps (12) and (14) comprises a retention filter (42).

6. A method according to claim 4, in which step (18) is carried out on a silica column.

7. A method according to claim 6, in which step (18) comprises at least the following sub-steps:
181) diluting the nucleic acid extract;
182) depositing the mixture on a silica column;
183) washing said column once or more times followed by drying; and
184) eluting nucleic acids retained on the silica column.

8. A method according to claim 7, in which sub-steps (181) to (184) are carried out under vacuum.

9. A method according to claim 1, in which step (12) consists of tangential microfiltration carried out using a retention filter (42) contained in the cartridge (40), said filter (42) being formed from cellulose nitrate or polycarbonate and having a mean pore diameter of 0.22 to 0.55 μm, preferably 0.45 μm.

10. A method according to claim 1, in which step (14) comprises a chemical lysis treatment consisting of the action of heat, in particular at 70° C., of a detergent contained in a lysis buffer comprising:
Tris-HCl (pH between 7 and 9, preferably about 8; and concentration between about 25 and 400 mM, preferably about 100 mM);
Chelex-100 (between about 3% and 60%, preferably about 15%);
and as appropriate, the following three components in combination:
EDTA (pH between about 7 and 9, preferably about 8; and concentration between about 10 and 100 mM, preferably about 40 mM);
NaCl (50 to 800 mM, preferably about 200 mM);
SDS (between about 0.5% and 8%, preferably about 2%);

11. A method according to claim 1, in which step (14) comprises a mechanical lysis treatment consisting of ultrasonication of microorganisms in a buffer comprising TENS and Chelex-100, preferably TENS 2× and 15% Chelex-100.

12. A method according to claim 11, in which ultrasonication is carried out hot, at about 70° C.

13. A method according to claim 1, in which step (14) comprises a mechanical lysis treatment consisting of dry sonication of the microorganisms.

14. A method according to claim 1, in which step (14) comprises a mechanical lysis treatment consisting of ultrasonication of microorganisms in a buffer comprising TENS and Chelex-100, preferably TENS 2× and 15% Chelex-100 and a chemical lysis treatment consisting of the action of heat, in particular at 70° C., of a detergent contained in a lysis buffer comprising:
Tris-HCl (pH between 7 and 9, preferably about 8; and concentration between about 25 and 400 mM, preferably about 100 mM):
Chelex-100 (between about 3% and 60%, preferably about 15%);
and as appropriate, the following three components in combination:
EDTA (pH between about 7 and 9, preferably about 8; and concentration between about 10 and 100 mM, preferably about 40 μM);
NaCl (50 to 800 mM, preferably about 200 mM);
SDS (between about 0.5% and 8%, preferably about 2%)

15. A method according to claim 1, further comprising the following preliminary steps:
26) grinding the complex sample, in particular of food; and
28) pre-treating enzymatically and chemically the obtained ground mixture.

16. A cartridge (40) for extracting nucleic acids from microorganisms, for use in carrying out the method of claim 1, said cartridge (40) comprising a retention filter (42) formed from cellulose nitrate or polycarbonate having a mean pore diameter of 0.22 to 0.55 μm, preferably 0.45 μm.

17. An automaton for extracting nucleic acids from microorganisms contained in a complex mixture, in particular of foods, or in water, to carry out the method according to claim 1.

18. An automaton according to claim 17 for extracting nucleic acids from microorganisms contained in a complex mixture, in particular of foods, or in water wherein, it comprises at least three modules (80, 82, 84), the first of said modules carrying out steps (12), (16) and (18), the second and third modules (82) and (84) carrying out step (14) of the extraction method according to claim 4.

19. An automaton according to claim 18, for extracting nucleic acids from microorganisms contained in a complex mixture, in particular of foods, or in water, wherein it comprises at least three modules (80, 82. 84). the first of said modules carrying out steps (12), (16) and (18), the second and third modules (82) and (84) carrying out step (14) of the extraction method wherein, the first module (80) is also capable of carrying out step (10) of the extraction method according to claim 2.

20. A device for extracting, detecting and, if appropriate quantifying nucleic acids of microorganisms contained in a complex mixture, in particular a food; or in water, comprising an automaton for extracting nucleic acids according to claim 17, coupled to an automaton for heat-dependent chain amplification of said nucleic acids.

21. A device according to claim 20, in which the automaton for heat-dependent chain amplification is rotary in type.
